(19) United States
(12) Patent Application Publication
(10) Pub. No.: US 2022/0205716 A1
(43) Pub. Date: Jun. 30, 2022

(54) ENCLOSURE AND METHOD FOR CONSTRUCTING AN ENCLOSURE OF AN APPARATUS FOR SEPARATION BY CRYOGENIC DISTILLATION

(71) Applicant: L'Air Liquide, Societe Anonyme pour l'Etude et l'Exploitation des Procedes Georges Claude, Paris (FR)

(72) Inventors: Alain BRIGLIA, Paris (FR); Remy KURTZ, Krakow (PL)

(73) Assignee: L'Air Liquide, Societe Anonyme pour l'Etude et l?Exploitation des Procedes Georges Claude, Paris (FR)

(21) Appl. No.: 17/555,292

(22) Filed: Dec. 17, 2021

(30) Foreign Application Priority Data
Dec. 24, 2020 (FR) FR 2014149

(51) Int. Cl. F25J 3/04

(52) U.S. Cl. CPC F25J 3/04945; F25J 2290/42

(57) ABSTRACT

An enclosure suitable for thermally insulating at least one distillation column comprising an elongate parallelepipedal framework and at least one part of a distillation column inside the framework, the enclosure or at least the lower part of the enclosure serving as support for the lifting means for installing elements in the column or for adding another part of the section of the column to that part of the column that is present in the enclosure or for adding another part of the enclosure.

### CROSS REFERENCE TO RELATED APPLICATIONS

This application claims the benefit of priority under 35 U.S.C. § 119 (a) and (b) to French patent application No. FR2014149, filed Dec. 24, 2020, the entire contents of which are incorporated herein by reference.

### FIELD OF THE INVENTION

The present invention relates to an enclosure and to a method for constructing an enclosure of an apparatus for separation by cryogenic distillation. The invention applies to any air separation apparatus to be assembled on site.

### BACKGROUND OF THE INVENTION

An enclosure of an apparatus for separation by cryogenic distillation comprises at least one distillation column, which is thermally insulated by disposing the insulation between the column and the walls of the enclosure. Said column contains packing for improving the transfer of mass and heat, and also liquid distributors evenly spread out in the column.

The industry requires ever-increasing quantities of oxygen and the apparatuses are often located in remote regions where the transport of bulky and heavy equipment is impossible because of the road infrastructure, such as the limitation on bridge crane heights.

In the case of the air separation apparatus for plants having a high capacity of 4000 t of oxygen per day up to 7000 t per day or more, the diameter of the column, which is generally transported horizontally, exceeds these transport limits.

In order to overcome this problem, several methods have been conceived in the past:
Manufacture of column segments that are able to conform to these transport limits in a workshop, then reassembling the column on site.
Manufacture of column in one piece in a remote workshop close to the building site, which column can then be transported on site and raised in one piece or in segments.

These methods have disadvantages, such as:
heavy lifting equipment
complex and expensive on-site assembly of the column section in sections
internal limitation within an existing complex that makes the faraway workshop a non-viable solution
increased cost of the installation of anew workshop at a distance when the plants are manufactured in different zones.

The present invention aims to overcome at least one of these problems.

### SUMMARY OF THE INVENTION

The present invention concerns a method for constructing a cryogenic separation apparatus in which the structure of the cold box is used as support for a travelling crane.

A travelling crane, also known as an overhead penthouse crane, is a mobile lifting machine that moves on a runway.

It can be composed of one or more beams on which a transfer trolley fitted with a hoist for lifting the load is moved transversely to the runway.

The runway can be the load-bearing structure of the lifting machine, composed of one or two runway beams and the supports thereof.

Usually, the runway is made up of two parallel beams which are surmounted by a dedicated rail and on which moves a trolley, from which a hook is suspended.

The runway beams are simple or continuous beams. The crane is referred to as double-beam when its frame is composed of two beams, the lifting trolley then being of the birail type.

According to one subject of the invention, there is provided is an enclosure suitable for thermally insulating at least one distillation column comprising an elongate parallelepipedal framework and at least one part of a distillation column inside the framework and lifting means, the enclosure or at least the lower part of the enclosure serving as support for the lifting means for installing elements in the column or for adding another part of the section of the column to that part of the column that is present in the enclosure or for adding another part of the enclosure, characterized in that the lifting means are composed of a travelling crane that is able to move a load in at least two dimensions, preferably three dimensions.

According to other optional aspects:
the enclosure comprises a support structure for the lifting means resting on the framework;
the support structure is able to be extended;
the enclosure comprises a temporary roof for protecting the inside of the at least one part of the column from bad weather;
the temporary roof rests on the support structure for the lifting means; and/or
the lifting means are composed of a travelling crane, the runway of which is fixed to the enclosure.

According to another subject of the invention, there is provided is a method for constructing an enclosure containing a distillation column using lifting means, in which method at least one part of the distillation column is disposed in at least one lower part of the enclosure and another part of the column and/or an upper part of the enclosure and/or internal elements of the column are put in place with the aid of lifting means assembled on the enclosure, characterized in that the lifting means are able to move the elements that they lift in at least two, even three dimensions.

According to other optional aspects:
the lifting means rest on a structure which rests on the lower part of the enclosure or on the enclosure
the structure extends in the vertical direction.

### BRIEF DESCRIPTION OF THE DRAWINGS

Further features and advantages of the invention will become apparent from the description hereinafter of embodiments, which are given by way of illustration but without any limitation, the description being given in relation with the following attached figures:

FIG. 1 illustrates the progression of the method according to the invention.

FIG. 2 illustrates certain step(s) of a method in accordance with an embodiment of the present invention.

FIG. 3 illustrates certain step(s) of a method in accordance with an embodiment of the present invention.

FIG. 4 illustrates certain step(s) of a method in accordance with an embodiment of the present invention.

FIG. 5 illustrates certain step(s) of a method in accordance with an embodiment of the present invention.

FIG. 6 illustrates certain step(s) of a method in accordance with an embodiment of the present invention.

FIG. 7 illustrates certain step(s) of a method in accordance with an embodiment of the present invention.

FIG. 8 illustrates certain step(s) of a method in accordance with an embodiment of the present invention.

FIG. 9 illustrates certain step(s) of a method in accordance with an embodiment of the present invention each illustrate steps of a method according to the invention.

### DETAILED DESCRIPTION OF THE INVENTION

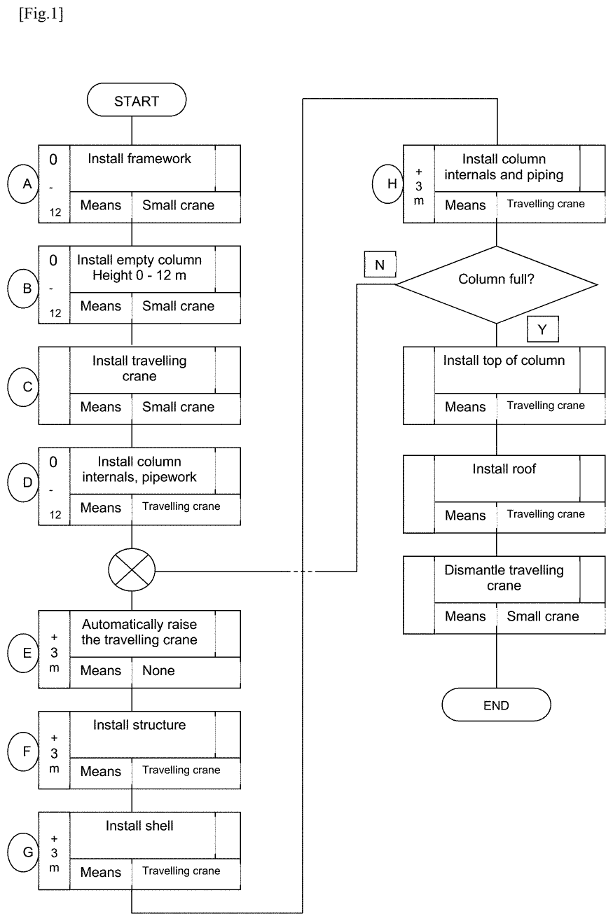

The basic method is made up of the steps A to H in FIG. 1.

FIG. 1 illustrates the steps of the method according to the invention, from the start to the end. To begin with, a framework that is to form part of a thermally insulated enclosure for a distillation column is installed having a parallelepipedal form with a main vertical axis, using a crane (step A). This framework is anchored in the ground and may be covered with metal sheeting. Then, at least one part of a distillation column that does not contain packing or distributors is disposed in the framework using the crane, whether by feeding it in through the open roof of the framework or by raising it so as to pass above an opening in the framework (step B). A travelling crane or another lifting means is installed with two parallel beams fixed to the framework, by using the crane (step C). This travelling crane subsequently serves to install structured packing and distributors in the column (column internals) and pipework on the outside of the column (step D).

If the column is filled, the final steps follow, these consisting in installing the top of the column so as to close it using the travelling crane, in closing the framework by installing the roof thereof with the travelling crane. Lastly, the travelling crane is dismantled using a crane.

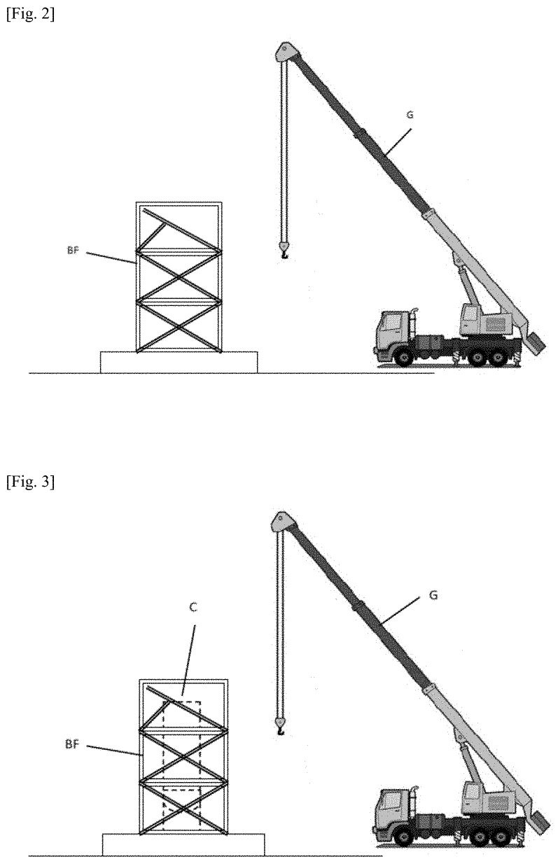

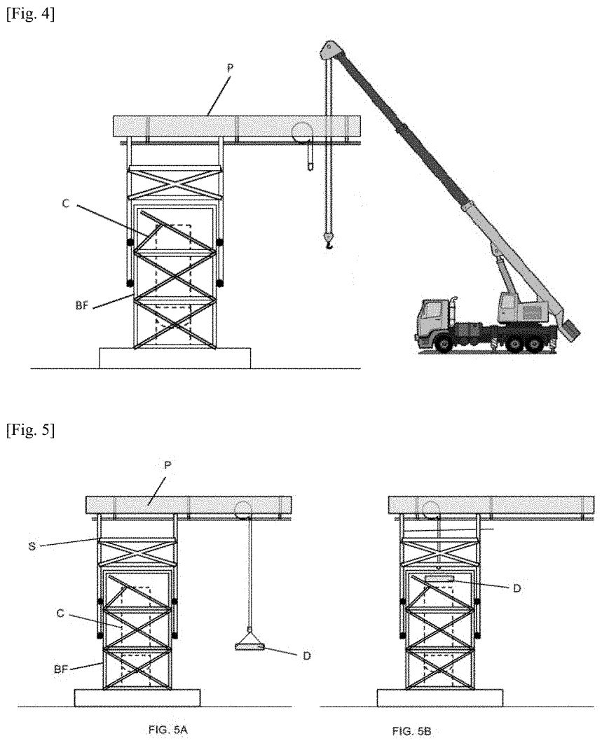

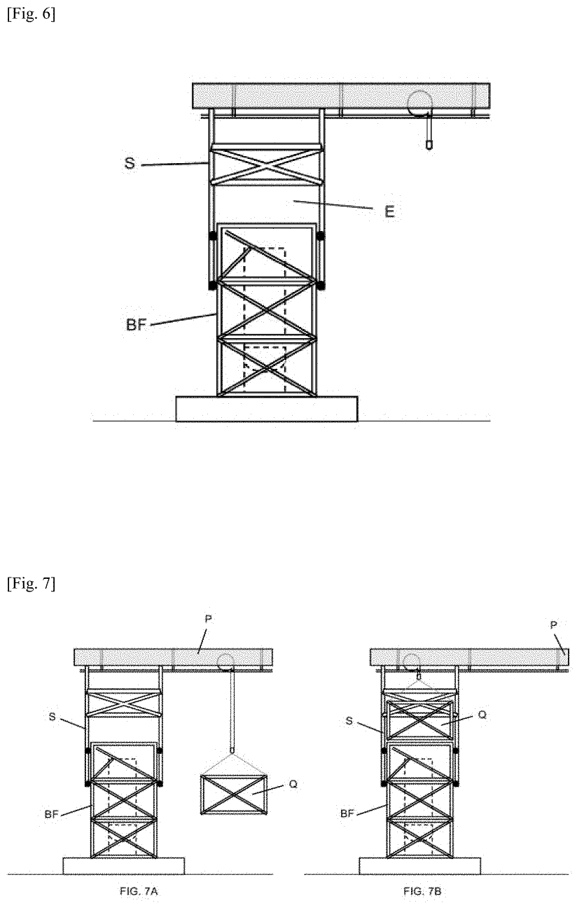

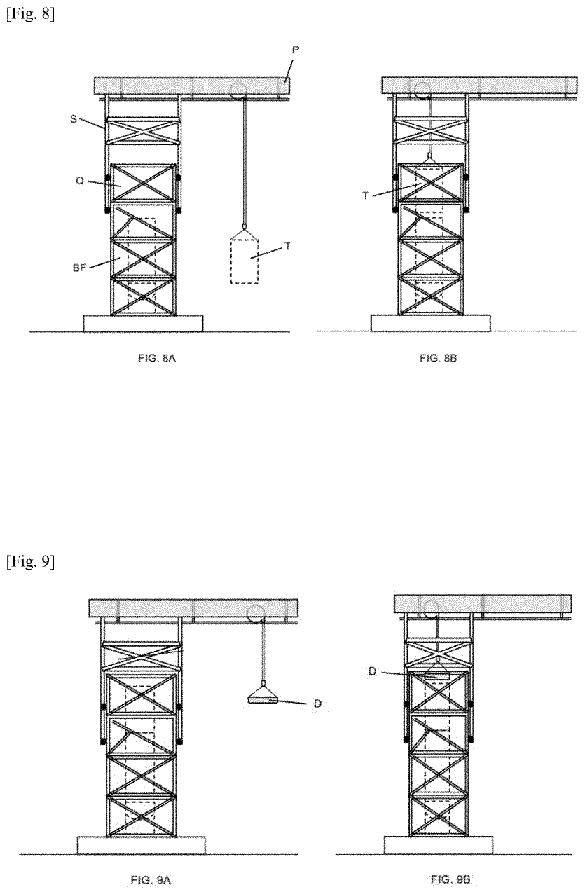

FIG. 2, FIG. 3, FIG. 4, FIG. 5, FIG. 6, FIG. 7, FIG. 8 and FIG. 9 each illustrate a successive step of a method according to the invention. To begin with, in FIG. 2, a first framework BF is installed having a parallelepipedal form with a main vertical axis, using a crane G (step A). This first framework is anchored in the ground and may be covered with metal sheeting. Then, at least one part C of a distillation column that does not contain packing or distributors is disposed in the first framework using the crane, whether by feeding it in through the open roof of the first framework or by raising it so as to pass above an opening in the first framework FIG. 3 (step B). A travelling crane P is installed with two parallel beams fixed to the first framework, through a structure S using the crane FIG. 4 (step C). The structure S is a second framework, which is assembled on the first framework and has a larger cross section than that of the first framework BF. The two beams extend in a horizontal direction and are parallel to one another.

The second framework S is open on the side where the two beams extend in order to allow the passage of packing and/or distributors and/or sections of a column.

The two beams are connected by a girder that bears a trolley, a hook being suspended from the trolley. The trolley can be moved in two dimensions and the hook can be lowered or raised. The runway of the travelling crane is fixed to the enclosure.

In this way, the lifting means can move a load in three dimensions and can move an element in order to install it in the enclosure.

This obviously involves reinforcing the structure of the first framework so as to support the additional weight of the second framework S and lifting means P.

This travelling crane subsequently serves to install structured packing and distributors D in the column (column internals) and pipework on the outside of the column FIG. 5 (step D). The packing can be manufactured next to the construction site using a mobile or temporary manufacturing workshop.

The distributors D for the column may also be manufactured next to the construction site using a mobile or temporary manufacturing workshop, or otherwise transported from a distant workshop.

Column sections may also be manufactured on site.

If the column is filled, a changeover to the final steps is made, these consisting in installing the top of the column so as to close it using the travelling crane, in closing the framework by installing the roof thereof with the travelling crane. Lastly, the travelling crane P is dismantled using a crane G.

If the column is not filled, the structure of the second framework can be extended FIG. 6 (step E) so as to be able to raise the lifting means to a higher level. It may be extended using a rack or a hydraulic ram so as to leave a space E allowing the insertion elements for constructing the column or the framework or for filling the column. This makes it possible in particular to extend the first framework by adding a framework part Q FIG. 7 (step F), raised and put in place by the lifting means. Then, a metal cylinder can be added to extend the shell of that part of the column that is present in the enclosure FIG. 8 (step G). The cylinder is raised and moved using the lifting means. This new section is filled FIG. 9 (step H) with packing and distributors D.

A temporary roof may be disposed above the structure S for protecting the inside of the column from bad weather.

The lifting means may be a temporary device or otherwise remain fixed at the top of the enclosure so as to facilitate maintenance.

The enclosure is filled with pulverulent insulation once the column has been constructed, in order to thermally insulate it.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

I claim:

1. A construction apparatus for an air separation device having an enclosure configured to thermally insulate at least one distillation column, the construction apparatus comprising:
an elongate parallelepipedal framework and at least one part of a distillation column inside the framework; and
lifting means,
wherein the enclosure or at least the lower part of the enclosure provides support for the lifting means for installing elements in the column or for adding another part of the section of the column to that part of the column that is present in the enclosure or for adding another part of the enclosure,
wherein the lifting means further comprise a travelling crane that is configured to move a load in at least two dimensions.

2. The construction apparatus according to claim 1, further comprising a support structure configured to all the lifting means to rest on the framework.

3. The construction apparatus according to claim 2, wherein the support structure is able to be extended.

4. The construction apparatus according to claim 1, comprising a temporary roof for protecting the inside of the at least one part of the column from bad weather.

5. The construction apparatus according to claim 1, wherein the lifting means is configured to move the elements that they lift in three dimensions

6. The construction apparatus according to claim 4, wherein the temporary roof rests on the support structure for the lifting means.

7. A method for constructing an enclosure containing a distillation column using lifting means, the method comprising the steps of
disposing at least one part of the distillation column in at least one lower part of the enclosure and
placing another part of the column and/or an upper part of the enclosure and/or internal elements of the column with the aid of lifting means assembled on the enclosure,
wherein the lifting means is configured to move the elements that they lift in at least two, even three dimensions.

8. The method according to claim 7, wherein the lifting means rest on a structure which rests on the lower part of the enclosure or on the enclosure.

9. Method according to claim 7, wherein the structure extends in the vertical direction.

10. The method according to claim 7, wherein the lifting means is configured to move the elements that they lift in three dimensions.
